(19) United States
(12) Patent Application Publication
(10) Pub. No.: US 2026/0231901 A1
(43) Pub. Date: Aug. 13, 2026

(54) PET HAMMOCK

(71) Applicant: JIANGSU ZHONGHENG PET ARTICLES JOINT-STOCK CO., LTD., Yancheng City (CN)

(72) Inventor: Bin QIU, Yangcheng City (CN)

(21) Appl. No.: 19/417,866

(22) Filed: Dec. 12, 2025

(30) Foreign Application Priority Data
Feb. 11, 2025 (CN) 202520214827.6

(51) Int. Cl. A01K 1/035

(52) U.S. Cl. CPC A01K 1/0353

(57) ABSTRACT

Provided is a pet hammock, including: a main body; a coupling member attached to the main body, the coupling member being configured to releasably couple the main body to a substantially smooth surface; and an actuation member attached to the coupling member, the actuation member being configured to enable the main body to move relative to the coupling member between a released position and a closed position, and from the released position to the closed position, the actuation member being configured to apply an axial force to the coupling member.

### CROSS REFERENCE TO THE RELATED APPLICATIONS

This application is based upon and claims priority to Chinese Patent Application No. 202520214827.6, filed on February 11, 2025, the entire contents of which are incorporated herein by reference.

### TECHNICAL FIELD

The present disclosure belongs to the technical field of pet supplies, and particularly relates to a pet hammock.

### BACKGROUND

In order to save space and provide various play options, some of existing pet hammocks are adhered to smooth surfaces such as glass through suction cups. However, in actual use of the conventional suction cup-based pet hammocks, for example, impact forces and vibrations generated when pets jump and play on the pet hammocks may very likely cause the suction cups to loosen and fall off, posing potential safety hazards and affecting the user experience.

### SUMMARY

An objective of the present disclosure is to provide a pet hammock to solve the above problem in the prior art.

A pet hammock is provided, including: a main body; a coupling member, where the coupling member is attached to the main body, and the coupling member is configured to releasably couple the main body to a substantially smooth surface; and an actuation member, where the actuation member is attached to the coupling member, the actuation member is configured to enable the main body to move relative to the coupling member between a released position and a closed position, and from the released position to the closed position, the actuation member is configured to apply an axial force to the coupling member.

In an embodiment, from the closed position to the released position, the actuation member is configured to release the axial force applied to the coupling member.

In an embodiment, the pet hammock further includes a guide channel, the guide channel is provided in the main body, the guide channel is configured to define a translational movement of the main body relative to the coupling member in an axial direction, and an end of the coupling member is arranged in the guide channel.

In an embodiment, the actuation member includes an arm and a spring, the arm is connected to the end of the coupling member arranged in the guide channel through a shaft, and the spring is arranged between the main body and the coupling member.

In an embodiment, a contour surface of the arm includes a planar section and a raised section, and the planar section and the raised section smoothly transition and are provided at an end of the arm adjacent to the main body.

In an embodiment, the pet hammock further includes a protrusion, the protrusion is arranged on the main body, and the protrusion is disengaged from the coupling member in the released position, and the protrusion is engaged with the coupling member in the closed position.

In an embodiment, the coupling member includes a connecting rod and a suction cup, a first end of the connecting rod is arranged in the guide channel and is connected to the arm through the shaft, and the suction cup is attached to a second end of the connecting rod.

In an embodiment, the main body includes a block and a platform member, the platform member is attached to the block, and in an embodiment, the guide channel is provided in the block.

In an embodiment, the platform member includes a first tube, a second tube, and a support portion, the first tube is attached to the block, the second tube is attached to the first tube, and the support portion is detachably attached to the first tube and the second tube.

In an embodiment, the platform member is pivotable relative to the block between a folded position and an unfolded position, and the first tube is attached to the block through a first connecting element, the second tube is attached to the first connecting element through a second connecting element, and in an embodiment, the first connecting element is a bolt, and the second connecting element is a nut.

In an embodiment, the pet hammock further includes a limiting device, the limiting device is configured to retain the platform member in the folded position and the unfolded position.

In an embodiment, the limiting device includes a groove and a bump, the groove is provided on the block, and the bump is arranged in the groove, and in an embodiment, a part of the first connecting element is arranged in the groove.

In conclusion, the present disclosure has the following advantages.
1. In the pet hammock according to the present disclosure, the main body is moved relative to the coupling member between the released position and the closed position by the actuation member, and from the released position to the closed position, the actuation member may apply the axial force to the coupling member, and the axial force allows a more effective negative pressure environment to be formed between the coupling member and the substantially smooth surface, so that the coupling member may more tightly adhere to the substantially smooth surface to prevent the coupling member from loosening and falling off.
2. In the pet hammock according to the present disclosure, the platform member may be pivoted to the folded position, so that the size of the pet hammock may be reduced, saving the storage space and making it easier to carry and transport. When the platform member is pivoted to the unfolded position, the platform member may provide a space for resting and playing to a pet, which makes the pet hammock suitable for more application scenarios and improves the user experience of the pet hammock.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a main body of a pet hammock in a released position according to an embodiment.

FIG. 2 is a schematic diagram of a main body of a pet hammock in a closed position according to an embodiment.

FIG. 3 is a schematic diagram of components of a pet hammock according to an embodiment as shown.

FIG. 4 is a sectional view of the components of the pet hammock according to the embodiment as shown in FIG. 3.

FIG. 5 is a schematic diagram of a pet hammock in an unfolded position according to an embodiment.

FIG. 6 is a schematic diagram of a pet hammock in a folded position according to an embodiment.

### DETAILED DESCRIPTION OF THE EMBODIMENTS

In the following description, numerous specific details are set forth in order to provide a more thorough understanding of the present disclosure. It will be apparent, however, to one skilled in the art, that the present disclosure may be practiced without one or more of these specific details. In other instances, well-known technical features are not described in order to avoid obscuring the present disclosure.

### Embodiment 1

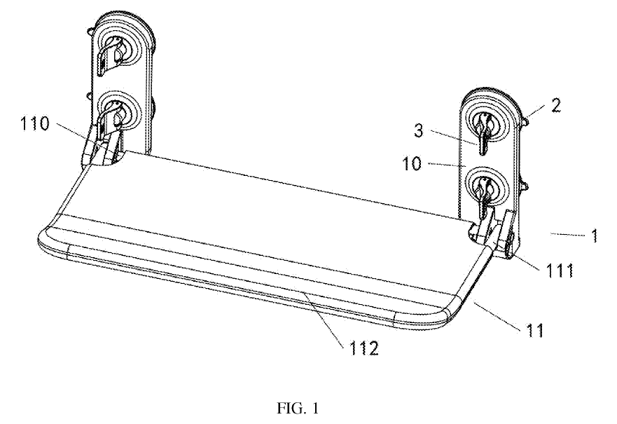

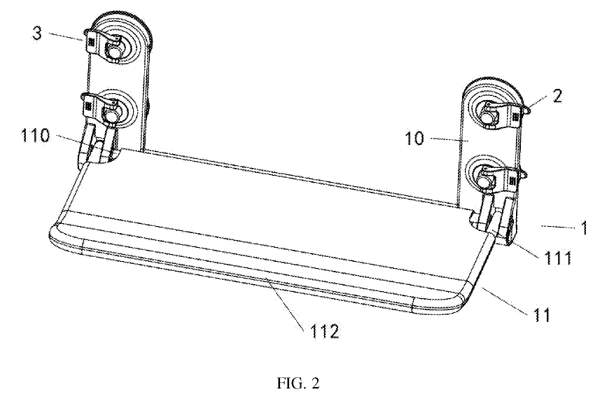

As shown in FIG. 1 and FIG. 2, a pet hammock according to Embodiment 1 includes: a main body 1; a coupling member 2, where the coupling member 2 is attached to the main body 1, and the coupling member 2 is configured to releasably couple the main body 1 to a substantially smooth surface; and an actuation member 3, where the actuation member 3 is attached to the coupling member 2, the actuation member 3 is configured to enable the main body 1 to move relative to the coupling member 2 between a released position and a closed position, and from the released position to the closed position, the actuation member 3 is configured to apply an axial force to the coupling member 2. The axial force allows a more effective negative pressure environment to be formed between the coupling member 2 and the substantially smooth surface, so that the coupling member 2 may more tightly adhere to the substantially smooth surface to prevent the coupling member 2 from loosening and falling off. From the closed position to the released position, the actuation member 3 is configured to release the axial force applied to the coupling member 2, so that the coupling member 2 may be dismounted easily.

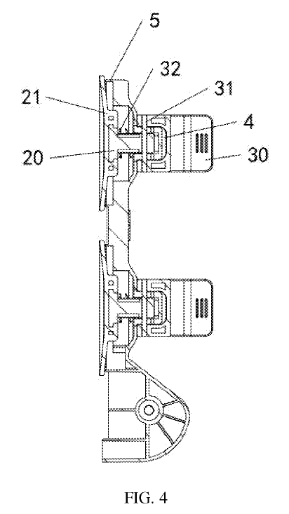

As shown in FIG. 4, the pet hammock further includes a guide channel 4 provided in the main body 1, the guide channel 4 is configured to define a translational movement of the main body 1 relative to the coupling member 2 in an axial direction, and an end of the coupling member 2 is arranged in the guide channel 4. The guide channel 4 ensures that the axial force applied by the actuation member 3 to the coupling member 2 is transmitted along a central axis of the coupling member 2 and therefore is more evenly distributed on the coupling member 2, which facilitates the maintenance of the negative pressure environment formed between the coupling member 2 and the substantially smooth surface.

As shown in FIG. 1 to FIG. 4, the actuation member 3 includes an arm 30 and a spring 32. The arm 30 is connected to the end of the coupling member 2 arranged in the guide channel 4 through a shaft 31, and the spring 32 is arranged between the main body 1 and the coupling member 2. A contour surface of the arm 30 includes a planar section 300 and a raised section 301, the planar section 300 and the raised section 301 smoothly transition and are provided at an end of the arm 30 adjacent to the main body 1. Therefore, the arm 30 is operated to rotate to allow the raised section 301 of the arm 30 to be engaged with the main body, and the main body 1 may axially translate from the released position to the closed position to compress the spring 32, thereby applying the axial force to the coupling member 2. On the contrary, the arm 30 is operated to rotate to allow the planar section 300 of the arm 30 to be engaged with the main body 1, the spring 32 is restored to an original shape, and the main body 1 may axially translate from the closed position to the released position, thereby releasing the axial force applied to the coupling member 2.

As shown in FIG. 4, the pet hammock further includes a protrusion 5 arranged on the main body 1, and the protrusion 5 is disengaged from the coupling member 2 in the released position, and the protrusion 5 is engaged with the coupling member 2 in the closed position. The protrusion 5 may apply an even pressure to the edge of the coupling member to further allow the coupling member 2 to better adhere to the substantially smooth surface.

As shown in FIG. 4, the coupling member 2 includes a connecting rod 20 and a suction cup 21. A first end of the connecting rod 20 is arranged in the guide channel 4 and is connected to the arm 30 through the shaft 31, and the suction cup 21 is attached to a second end of the connecting rod 20. The connecting rod 20 is engaged with the guide channel 4 in a frictional manner, so that the main body 1 is allowed to axially translate between the released position and the closed position with the engagement of the connecting rod 20 and the guide channel 4.

As shown in FIG. 1 and FIG. 2, the main body 1 includes a block 10 and a platform member 11 attached to the block 10, and the guide channel 4 is provided in the block 10. The platform member 11 includes a first tube 110 attached to the block 10, a second tube 111 attached to the first tube 110, and a support portion 112 detachably attached to the first tube 110 and the second tube 111.

### Embodiment 2

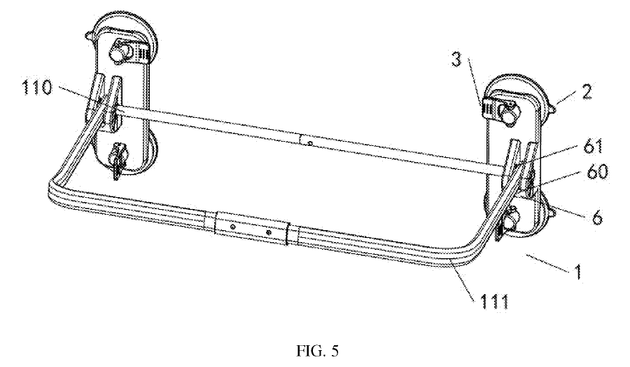

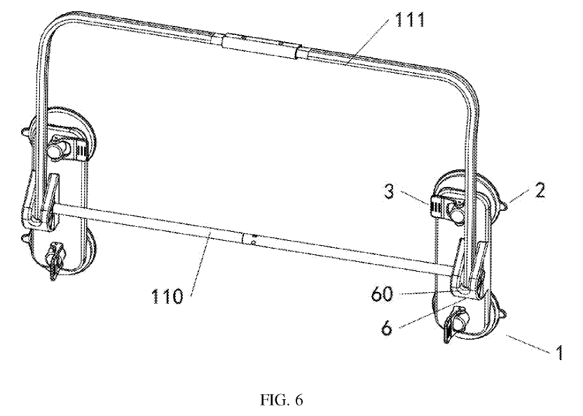

As shown in FIG. 5 and FIG. 6, different from Embodiment 1, the platform member 11 of the pet hammock according to Embodiment 2 is pivotable between a folded position and an unfolded position relative to the block 10, and the first tube 110 is attached to the block 10 through a first connecting element, and the second tube 111 is attached to the first connecting element through a second connecting element. For example, the first connecting element is a bolt, and the second connecting element is a nut. The platform member 11 may be pivoted to the folded position, so that the size of the pet hammock may be reduced, saving the storage space and making it easier to carry and transport. When the platform member 11 is pivoted to the unfolded position, the platform member 11 may provide a space for resting and playing to a pet, which makes the pet hammock suitable for more application scenarios and improves the user experience of the pet hammock.

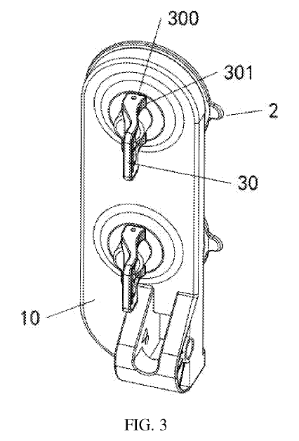

As shown in FIG. 3, FIG. 5, and FIG. 6, the pet hammock further includes a limiting device 6 configured to retain the platform member 11 in the folded position and the unfolded position. The limiting device 6 includes a groove 60 provided on the block 10 and a bump 61 arranged in the groove 60, and a part of the first connecting element is arranged in the groove 60, and in the unfolded position, a part of the second tube 111 may also be arranged in the groove 60, thereby retaining the platform member 11 in the unfolded position. When the platform member 11 is pivoted to the folded position, a part of the second tube 111 is engaged with the bump 61, thereby retaining the platform member 11 in the folded position.

The preferred embodiments of the present disclosure are described in detail with reference to the accompanying drawings, however, the present disclosure is not limited to the specific details of the above embodiments, and various equivalent changes may be made to the technical solution of the present disclosure within the technical idea of the present disclosure, and these equivalent changes are all within the protection scope of the present disclosure.

What is claimed is:

1. A pet hammock, comprising:
a main body;
a coupling member, wherein the coupling member is attached to the main body, and the coupling member is configured to releasably couple the main body to a substantially smooth surface; and
an actuation member, wherein the actuation member is attached to the coupling member, the actuation member is configured to enable the main body to move relative to the coupling member between a released position and a closed position, and from the released position to the closed position, the actuation member is configured to apply an axial force to the coupling member.

2. The pet hammock according to claim 1, further comprising
a guide channel, wherein the guide channel is provided in the main body, and the guide channel is configured to define a translational movement of the main body relative to the coupling member in an axial direction.

3. The pet hammock according to claim 2, wherein an end of the coupling member is arranged in the guide channel.

4. The pet hammock according to claim 3, wherein the actuation member comprises an arm and a spring, the arm is connected to the end of the coupling member arranged in the guide channel through a shaft, and the spring is arranged between the main body and the coupling member.

5. The pet hammock according to claim 4, wherein a contour surface of the arm comprises a planar section and a raised section, and the planar section and the raised section smoothly transition and are provided at an end of the arm adjacent to the main body.

6. The pet hammock according to claim 1, further comprising a protrusion, wherein the protrusion is arranged on the main body, and the protrusion is disengaged from the coupling member in the released position, and the protrusion is engaged with the coupling member in the closed position.

7. The pet hammock according to claim 1, wherein the main body comprises a block and a platform member, and the platform member is attached to the block.

8. The pet hammock according to claim 7, wherein the platform member is pivotable relative to the block between a folded position and an unfolded position.

9. The pet hammock according to claim 8, further comprising a limiting device, wherein the limiting device is configured to retain the platform member in the folded position and the unfolded position.
